(19) United States
(12) Patent Application Publication
(10) Pub. No.: US 2026/0117848 A1
(43) Pub. Date: Apr. 30, 2026

(54) MODULAR STEEL BELT CONTINUOUSLY VARIABLE TRANSMISSION SYSTEM

(71) Applicant: TEAM Industries, Inc., Bagley, MN (US)

(72) Inventors: Jordan E. Fisk, Bemidji, MN (US); Michael Allen Mueller, Bemidji, MN (US); Brandon P. Lenk, Shevlin, MN (US)

(73) Assignee: TEAM Industries, Inc., Bagley, MN (US)

(21) Appl. No.: 19/366,130

(22) Filed: Oct. 22, 2025

Related U.S. Application Data
(60) Provisional application No. 63/714,608, filed on Oct. 31, 2024.

(51) Int. Cl. F16H 37/02; B60K 17/02; B60K 17/08; F16H 57/02; F16H 57/029; F16H 57/035; F16H 63/30

(52) U.S. Cl. CPC F16H 37/021; B60K 17/02; B60K 17/08; F16H 57/029; F16H 57/035; F16H 63/3023; F16H 2057/02043

(57) ABSTRACT

A modular SBCVT system including a housing, a SBCVT, a hydraulic system and a SBCVT system output is provided. The SBCVT, within the housing, includes a primary pulley, a secondary pulley and a steel belt. The primary pulley is in operational communication to receive engine torque. The endless looped member is in operational communication with the primary pulley and secondary pulley to convey torque between the pulleys. The hydraulic system is contained within the housing. The hydraulic system configured to control at least the primary pulley and secondary pulley. The SBCVT system output is in operational communication with the secondary pulley of the SBCVT. The SBCVT system output is configured to engage an input shaft of an existing gear box.

This application claims priority to U.S. Provisional Application Ser. No. 63/714,608, same title herewith, filed on Oct. 31, 2024, which is incorporated in its entirety herein by reference.

### BACKGROUND

Current offroad vehicles, such as, but not limited to, side-by-side vehicles, are equipped with a rubber belt continuously variable transmission (CVT). A rubber belt CVT uses centrifugal force to vary the drive ratio of the CVT depending on the engine speed. The CVT drives a gearbox that may contain one or more forward gears (most commonly a high range and a low range) and a reverse gear. One downside to a rubber belt CVT is that the CVT ratio is dependent on engine revolutions per minute (RPM). This may lead to the CVT being in a non-optimal drive ratio during most driving conditions. Being in a non-optimal drive ratio can lead to poor noise, vibration and harshness (NVH), poor performance, reduced efficiency, and reduced durability of the rubber belt.

A steel belt CVT offers an option to replace a rubber belt CVT to improve on these characteristics. The steel belt (SB) CVT uses a hydraulic control unit to control the ratio independently of engine RPM, which allows the SBCVT to be in the optimal drive ratio for all driving conditions. This improves performance, NVH, efficiency, and durability. Current on-road SBCVT systems are designed with the gearbox built into the SBCVT system.

For the reasons stated above and for other reasons stated below which will become apparent to those skilled in the art upon reading and understanding the present specification, there is a need in the art for an effective and efficient SBCVT for use in different applications.

### SUMMARY

The following summary is made by way of example and not by way of limitation. It is merely provided to aid the reader in understanding some of the aspects of the subject matter described. Embodiments provide a modular SBCVT system that may be used with existing gearboxes.

In one embodiment, a modular SBCVT system is provided that includes a housing, a SBCVT, a hydraulic system and a SBCVT system output. The SBCVT is contained within the housing. The SBCVT includes at least a primary pulley, a secondary pulley and a steel belt. The primary pulley is in operational communication to receive engine torque. The endless looped member is in operational communication with the primary pulley and secondary pulley to convey torque between the primary pulley and secondary pulley. The hydraulic system is contained within the housing. The hydraulic system configured to control at least the primary pulley and the secondary pulley. The SBCVT system output is in operational communication with the secondary pulley of the CVT. The SBCVT system output is configured to engage an input shaft of an existing gear box.

In another embodiment, another modular SBCVT system is provided. The system includes a housing with the SBCVT contained within the housing. The SBCVT includes a primary pulley in operational communication to receive engine torque, a secondary pulley, and a steel belt. The steel belt is in operational communication with the primary pulley and the secondary pulley to convey torque between the primary pulley and the secondary pulley. An active torque management (ATM) clutch is contained within the housing. The ATM clutch is in operational communication with the secondary pulley of the SBCVT. A hydraulic system is contained within the housing. The hydraulic system is configured to control at least the primary pulley, the secondary pulley and the ATM clutch. The SBCVT system output is in operational communication with the secondary pulley of the SBCVT. The SBCVT system output is configured to engage an input shaft of a gearbox.

In yet another embodiment, a vehicle including an engine to generate engine torque and a modular SBCVT system is provided. The SBCVT system includes a housing. A SBCVT is contained within the housing. The SBCVT includes a primary pulley, a secondary pulley, and a steel belt. The primary pulley is in operational communication to receive engine torque. The steel belt is in operational communication with the primary pulley and the secondary pulley to convey torque between the primary pulley and the secondary pulley. A hydraulic system is contained within the housing. The hydraulic system is configured to control at least the primary pulley and the secondary pulley. A SBCVT system output is in operational communication with the secondary pulley of the SBCVT. The SBCVT system output is configured to engage an input shaft of a gearbox. The gearbox is in operational communication with the SBCVT system. Wheels are in operational communication with the gearbox.

### BRIEF DESCRIPTION OF THE DRAWINGS

The present invention can be more easily understood and further advantages and uses thereof will be more readily apparent, when considered in view of the detailed description and the following figures in which:

FIG. 1A is a first side perspective view of a modular SBCVT system unattached to a gearbox according to an example aspect of the present invention;

FIG. 1B is a second side perspective view of the modular SBCVT system unattached to the gearbox of FIG. 1A;

FIG. 2A is a partial cross-sectional top view of the modular SBCVT system of FIG. 1A attached to the gearbox according to an example aspect of the present invention;

FIG. 2B is a partial close-up cross-sectional top view of the modular SBCVT system of FIG. 1A;

FIG. 3 is a close-up cross-sectional view of an ATM clutch and SBCVT system output of the modular SBCVT system of FIG. 1A;

FIG. 4 is a close-up cross-sectional view of a forward/reverse system and hydraulic system of the modular SBCVT system of FIG. 1A;

FIG. 5 illustrates a block diagram of a vehicle that includes the modular SBCVT system of FIG. 1A;

FIG. 6 illustrates a block diagram of a vehicle that includes another modular SBCVT system according to an example aspect of the present invention;

FIG. 7A is a first side perspective view of another modular SBCVT system unattached to a gearbox according to an example aspect of the present invention;

FIG. 7B is a second side perspective view of the modular SBCVT system unattached to the gearbox of FIG. 7A;

FIG. 8A is a cross-sectional top view of the modular SBCVT system of FIG. 7A attached to the gearbox according to an example aspect of the present invention;

FIG. 8B is a close-up cross-sectional top view of the modular SBCVT system of FIG. 7A illustrating an interface between the modular SBCVT system and the gearbox according to an example aspect of the present invention;

FIG. 9 illustrates a block diagram of a vehicle that includes the modular SBCVT system of FIG. 7A; and

FIG. 10 illustrates a block diagram of a vehicle that includes another modular SBCVT system according to an example aspect of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments of the present invention provide a modular steel belt continuously variable transmission (SBCVT) system. Although, the present invention has applications across different vehicle platforms, the present invention has particular application to off-road vehicles where production volumes are relatively low and vehicle architecture remains the same across several years. Further, it is very expensive to re-design vehicle architecture to accept a SBCVT system with a common integrated gearbox. In one example embodiment of the present invention, a modular SBCVT system is provided that may replace a rubber belt CVT without requiring challenging major vehicle architecture changes typically needed to implement a SBCVT into an off-road vehicle. Modular SBCVT system embodiments may replace a rubber belt CVT, in the same vehicle architecture and package space, and using the existing gearbox that the rubber belt CVT system used. This modularity is unique to SBCVT systems, as discussed above, current SBCVT systems incorporate the gearbox into the design. Embodiments of the modular SBCVT system allow for prior vehicle architecture to remain the same, while still being able to accept a modular SBCVT system. Additionally, the modular SBCVT system design of embodiments may reduce the cost of the overall vehicle since implementation of the modular SBCVT system can benefit from the higher production volumes of the existing gearbox, and the existing vehicle architecture. Further the design may also lead to a faster lead-time to production, as there is no additional development required to develop a new vehicle architecture.

Embodiments include modular SBCVT system interfaces that connect the modular SBCVT system with the engine through a modular SBCVT input shaft spline. In one example, the SBCVT input shaft is directly coupled to an engine crank shaft. In another embodiment the SBCVT input shaft is coupled to an engine crank shaft through a torsional spring damper. The SBCVT input shaft may further be coupled to one or more of forward clutch friction plates, a sun gear in a planetary, and a hydraulic pump drive gear or sprocket as discussed below.

Language such as “coupled with,” “in communication with,” and “in operational communication with” along with derivations, may be used herein. These terms indicate that two or more elements are interacting with each other. The interaction between the two or more elements may be direct or through intermediate elements. Further the interaction may be physical or non-physical. Physical interaction includes physical connecting of the two or more elements. Non-physical interaction includes, but are not limited to, interactions through signals, such as, but not limited to, power signals, communication signals, etc.

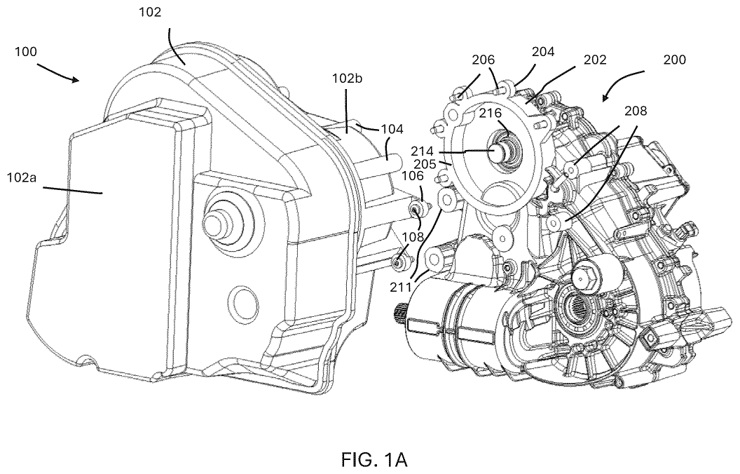

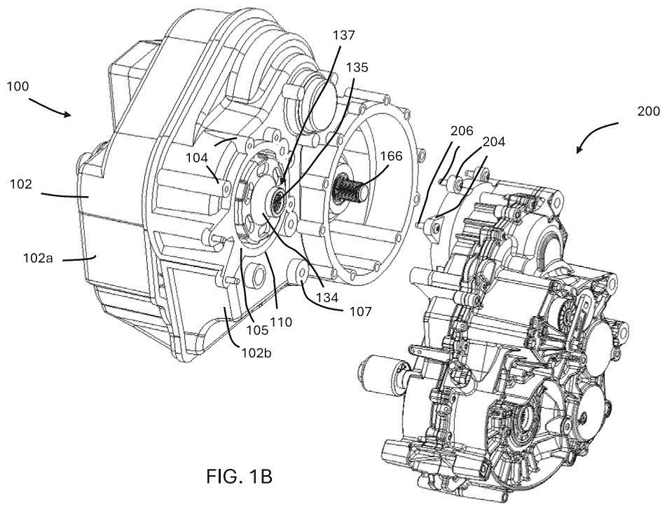

FIGS. 1A and 1B illustrate side perspective views of a modular SBCVT system 100 of an embodiment and a gearbox 200 (transmission or transaxle) known in the art. The modular SBCVT system 100 includes a CVT housing 102 that includes a first portion 102a and a second portion 102b. The second portion 102b of the housing includes CVT bolt bosses 104. Fasteners 206 passing through engagement flanges 204 of a transmission housing 202 of the gearbox 200 (transmission) into the bolt bosses 104 connect in part the modular SBCVT system 100 to the gearbox 200. Further illustrated are transmission bolt bosses 208. Fasteners 108 passing through engagement flanges 106 of the second portion 102b of the CVT housing 102 of the modular SBCVT system 100 and engaging the transmission bolt bosses 208 also connect in part the modular SBCVT system 100 to the gearbox 200. Further illustrated are existing engine mount bolt bosses 211 on the transmission or gearbox housing 202 that are used to couple the transmission to an engine and bolt bosses 107 on the second portion 102b of the housing 102 of the modular SBCVT system 100.

The second portion 102b of the CVT housing 102 includes a SBCVT sealing gasket face 105 that aligns with a transmission sealing gasket face 205. A sealant is used between the CVT sealing gasket face 105 and the transmission sealing gasket face 205. The gearbox 200 is illustrated as including a transmission input shaft 214. A lip seal 216 is positioned between the modular SBCVT system 100 and the gearbox 200 which may be a transmission or transaxle.

In this example, the second portion 102b of the housing 102 includes a SBCVT gasket face 105 that interfaces with a gearbox gasket face 205 on the gearbox housing 202 to seal off the modular SBCVT system 100 from the outside environment. The lip seal 216 in the existing gearbox 200 seals off a SBCVT oil cavity of the modular SBCVT system 100 from a gearbox oil cavity of the gearbox 200. The modular SBCVT system 100 bolts to the existing gearbox 200 using any or all of bolts around the SBCVT gasket face 105, existing engine mount bolts, additional bolt bosses, and/or additional bracketry.

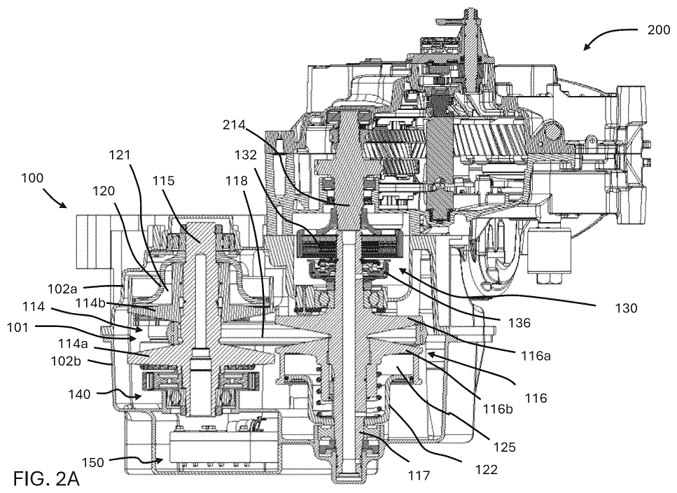

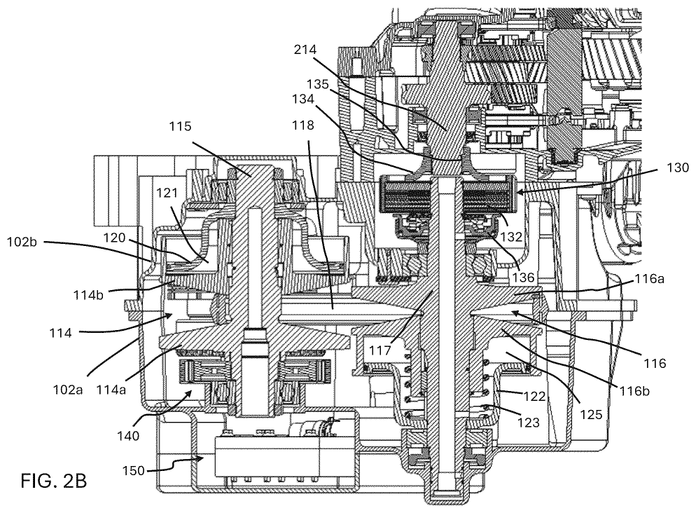

FIG. 2A illustrates a cross-sectional top view of modular SBCVT system 100 coupled to gearbox 200. Further FIGS. 2A and 2B illustrate close up partial cross-sectional top views of the modular SBCVT system 100 coupled to gearbox 200. The modular SBCVT system 100 includes CVT 101 with a primary pulley 114 and a secondary pulley 116. The primary pulley 114 includes a primary fixed sheave 114a and a primary movable sheave 114b. The secondary pulley 116 includes a secondary fixed sheave 116a and a secondary movable sheave 116b. An endlessly looped member, which may be a steel belt 118 in examples, couples torque between the primary pulley 114 and the secondary pulley 116. Further illustrated is a primary stator 120 that is axially fixed on a primary shaft 115 of the primary pulley 114. A secondary stator 122 is further axially fixed on a secondary shaft 117 of the secondary pulley 116. A secondary spring 123 is positioned so one end of the spring 123 engages an inside surface of the secondary stator 122 and a second end of the spring 123 engages the secondary movable sheave 116b to create a biasing force on the secondary movable sheave 116b away from the secondary stator 122 towards the secondary fixed sheave 116a of the secondary pulley 116.

Further mounted on the secondary shaft 117 is an active torque management (ATM) clutch 130. The ATM clutch 130 includes a clutch pack of alternating positioned clutch plates 132. One set of clutch plates of the clutch plates 132 are coupled to an ATM clutch outer basket 134 and one set of clutch plates of the clutch plates 132 are coupled to the secondary shaft 117 of the secondary pulley 116. The ATM clutch outer basket 134 is configured to be coupled to the transmission input shaft 214. The ATM clutch 130 is configured to selectively pass torque between the SBCVT system 100 and the gearbox 200. An ATM clutch piston 136 regulates the amount of torque that is allowed to be transferred between torque between the SBCVT system 100 and the gearbox 200.

The modular SBCVT system 100 further includes a driven gear 140 (pre-reduction gearing or sprocket) and a hydraulic system 150 (hydraulic block or hydraulic control unit). The hydraulic system 150 may control the primary pulley 114, the secondary pulley 116, a forward/reverse system 161 discussed below, and the ATM clutch 130. The hydraulic system 150 includes a hydraulic pump, valves that control hydraulic pressure, and fluid passages to the primary pulley 114, the secondary pulley 116, the forward/reverse system 161, and the ATM clutch 130. The secondary movable sheave 116b may also be rotationally coupled to the secondary fixed sheave 116a of the secondary pulley 116. Further, the secondary fixed sheave 116a is rotationally coupled to the ATM clutch friction plates (alternating positioned clutch plates 132). The modular SBCVT system output spline 135 may interface with an existing gearbox 200 (transmission or transaxle).

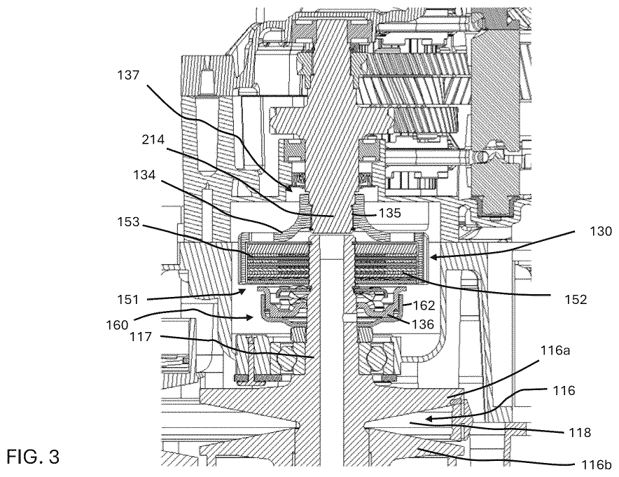

FIG. 3 illustrates a close-up partial cross-sectional view of the secondary pulley 116 and the ATM clutch 130 of the modular SBCVT system 100 and a portion of the gearbox 200 (transmission). The ATM clutch 130 includes a clutch pack 151 that includes a plurality of alternating plates that include ATM clutch reaction plates 153 and ATM clutch friction plates 152. The ATM clutch reaction plates 153 are coupled to the ATM clutch outer basket 134 and the ATM clutch friction plates 152 are coupled to the secondary shaft 117. A CVT system output 137, in this example, includes the ATM clutch outer basket 134 that includes a modular SBCVT system output spline 135 that engages splines on the transmission input shaft 214.

An ATM actuator 160 includes the ATM clutch piston 136 and an ATM stator 162. The ATM stator 162 is axially fixed on the secondary shaft 117. Hydraulic pressure is used to selectively move the ATM clutch piston 136 to engage the clutch pack of the ATM clutch 130 to selectively set the amount of torque that passes between the secondary shaft 117 and the transmission input shaft 214.

When the ATM clutch piston 136 is engaged, the ATM clutch friction plates 152 and the ATM clutch reaction plates 153 are coupled together, which allows torque transfer to the output of the modular SBCVT system 100. The ATM clutch pressure is supplied and controlled by the hydraulic system 150 (hydraulic control unit). The Modular SBCVT system 100 of embodiment interfaces with the existing gearbox, transmission, or transaxle by rotationally coupling the modular SBCVT system output spline 135 to a gearbox input spline 214.

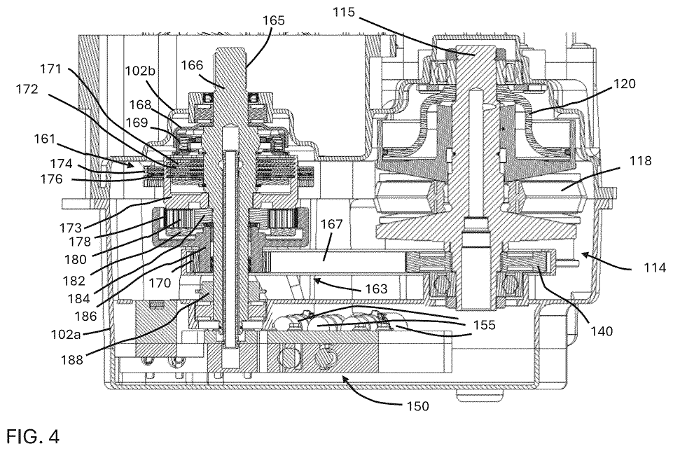

FIG. 4 illustrates a close-up partial cross-sectional view of the primary pulley 114, hydraulic system 150 (hydraulic control unit), and the forward/reverse system 161 that includes a modular SBCVT system input shaft 166. Engine torque from an engine is coupled to the modular SBCVT system input shaft 166. The modular SBCVT system input shaft 166 includes an input spline 165. A pre-reduction system 163 that includes a pre-reduction endless looped member, which may be a pre-reduction chain 167, couples torque between the primary shaft 115 and the forward/reverse system 161. The pre-reduction system 163 is configured to reduce a revolutions per minute (RPM) output of the engine applied to the primary pulley 114 of the CVT 101. The pre-reduction chain 167 engages a pre-reduction driven gear 140 (or sprocket) engaged with the primary shaft 115 and a pre-reduction drive gear 170 (or sprocket) to transfer torque between the modular SBCVT system input shaft 166 and the primary shaft 115 of the primary pulley 114. The pre-reduction drive gear 170 in the example, is engaged with a planetary output spline 186 discussed below. The pre-reduction chain 167, in another example, may be a gear mesh. A pre-reduction ratio is dependent on the number of teeth of the pre-reduction drive gear 170 (or sprocket) and the pre-reduction driven gear 140 (or sprocket).

The forward/reverse system 161 includes a forward clutch stator 168 and a forward clutch piston 169. A forward clutch pack includes alternating forward clutch friction plates 171 and forward clutch reaction plates 172. The forward clutch friction plates 171 are coupled to the modular SBCVT system input shaft 166 and the forward clutch reaction plates 172 are coupled to a clutch middle basket 173. A reverse clutch pack includes alternating reverse clutch reaction plates 174 and reverse clutch friction plates 176. The reverse clutch reaction plates 174 are grounded (coupled to a housing) and the reverse friction plates 176 are coupled to an outside surface of the clutch middle basket 173. The forward/reverse system 161 further includes a ring gear 178, at least two planet gears 180, planet carrier 182, sun gear 184 and planetary output spline 186.

The clutch middle basket 173 is bolted to the planet carrier 182, which couples the at least two planet gears 180 together. When the forward clutch piston 169 is engaged, the forward clutch friction plates 171 and forward clutch reaction plates 172 become coupled together, which fixes the sun gear 184 to the planet carrier 182 (through the clutch middle basket 173). This drives the ring gear 178, and a planetary output at a one to one ratio to a planetary input. When a reverse clutch piston (not pictured), is engaged, and the forward clutch piston 169 is dis-engaged, the reverse clutch friction plates 176, and the reverse clutch reaction plates 174 (coupled to a housing), become coupled together. This couples the planet carrier 182 to the housing (through the clutch middle basket 173). This drives the planetary output in a reverse direction at a ratio dependent on the number of teeth in the sun gear 184, planet gears 180, and ring gear 178.

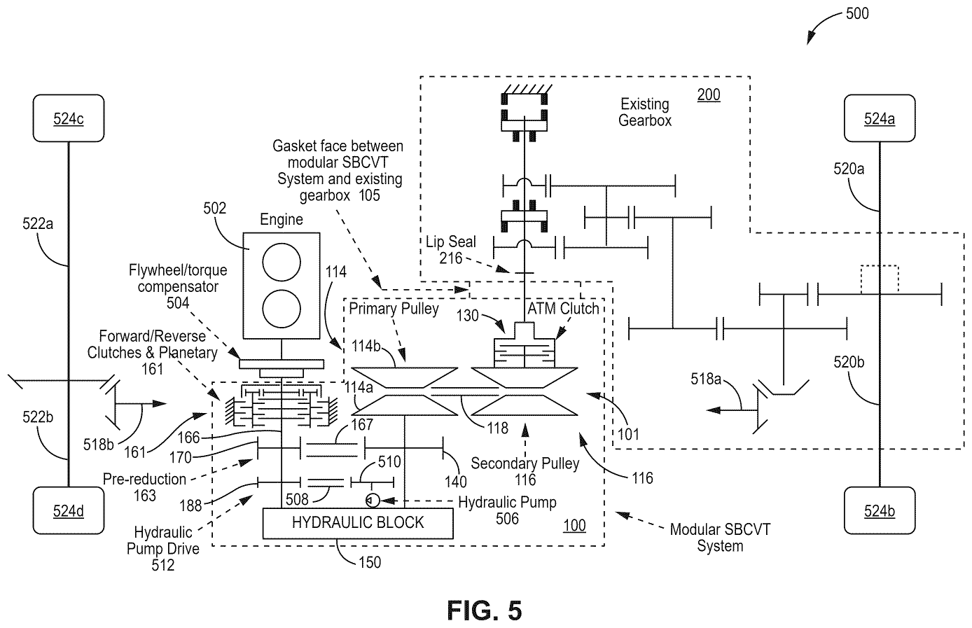

Also illustrated is a hydraulic pump drive sprocket 188 (or gear) used to operate a hydraulic pump 506 (illustrated in FIG. 5). Further illustrated in FIG. 4 are hydraulic valves 155 of a hydraulic system 150 (hydraulic block or hydraulic control unit). The hydraulic pump drive sprocket 188 (or gear) drives the hydraulic pump 506, which supplies hydraulic pressure to a hydraulic control unit in the hydraulic system 150.

FIG. 5 includes a block diagram of an example vehicle 500 that includes the modular SBCVT system 100. Vehicle 500 includes an engine 502. The engine 502 may include any type of engine/motor that produces torque including, but not limited to, an internal combustible engine and an electric motor. In this example, a flywheel/torque compensator 504 is in operational communication with the engine 502. The flywheel/torque compensator 504 is in operational communication with the modular SBCVT system input shaft 166 of the modular SBCVT system 100. The hydraulic pump drive sprocket 188 further includes an endless looped member 508 and a hydraulic pump driven sprocket 510 of a hydraulic pump drive 512.

Torque from the gearbox 200 (transmission), is communicated to back wheels 524a and 524b and front wheels 524c and 524d of the vehicle 500 via back half shafts 520a and 520b and front half shafts 522a and 522b and prop shafts 518a and 518b in this example.

In an example, the hydraulic pump drive sprocket 188 drives the hydraulic pump 506, which supplies hydraulic pressure to the hydraulic system 150 (hydraulic control unit). The primary movable sheave 114b is rotationally coupled to the primary fixed sheave 114a in an example. The steel belt 118 is rotationally coupled to the movable and fixed sheaves through clamp force which is supplied and controlled via the hydraulic system 150 (hydraulic control unit). A primary piston chamber 121 (best illustrated in FIG. 2A), which is made up of an interface between the primary stator 120 and the primary movable sheave 114b, applies the clamp force on the steel belt 118 through the primary movable sheave 114b. The primary movable sheave 114b can translate axially along the primary shaft 115 of the primary pulley 114, depending on the clamp force provided, to control the ratio of the steel belt CVT.

The steel belt 118 is rotationally coupled to the secondary pulley 116. A clamp force is applied by the secondary movable sheave 116b on steel belt 118. A secondary piston chamber 125 is made by the interface between secondary stator 122 and the secondary movable sheave 116b (as best illustrated in FIG. 2B). The clamp force is supplied by the hydraulic system 150. The clamp force can vary, which allows the secondary movable sheave 116b to translate axially along the secondary shaft 117, in unison with the translation of the primary movable sheave 114b to change the ratio of the SBCVT.

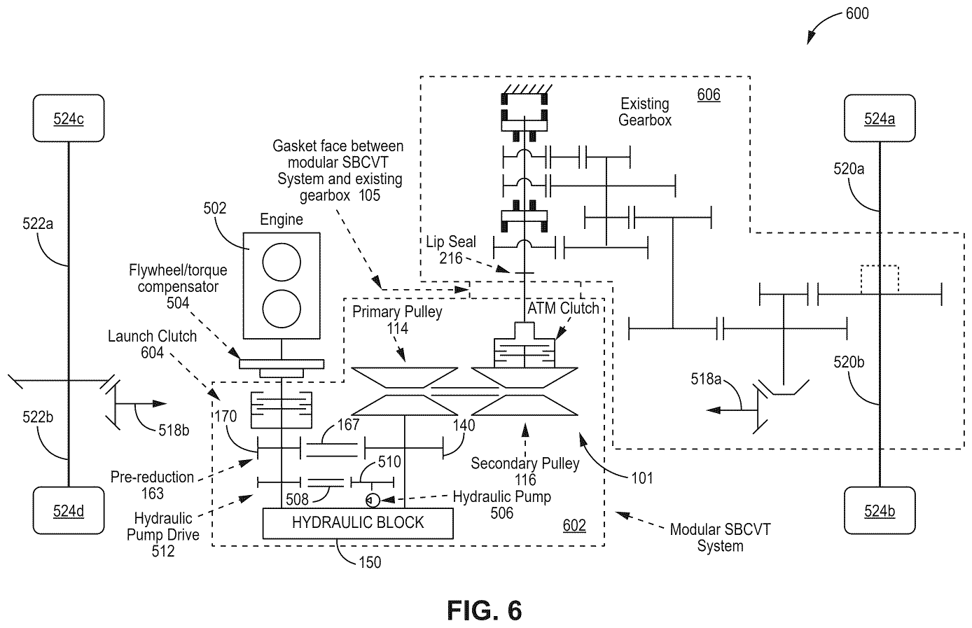

Another example of the vehicle 600 is illustrated in FIG. 6. In this example, the modular SBCVT system 602 replaces the forward/reverse clutch and planetary 161 with a launch clutch 604. The launch clutch 604 is positioned between the flywheel/torque compensator 504 and the pre-reduction drive gear 170 of the pre-reduction gearing. In this example the gearbox 606 includes the forward/reverse gearing.

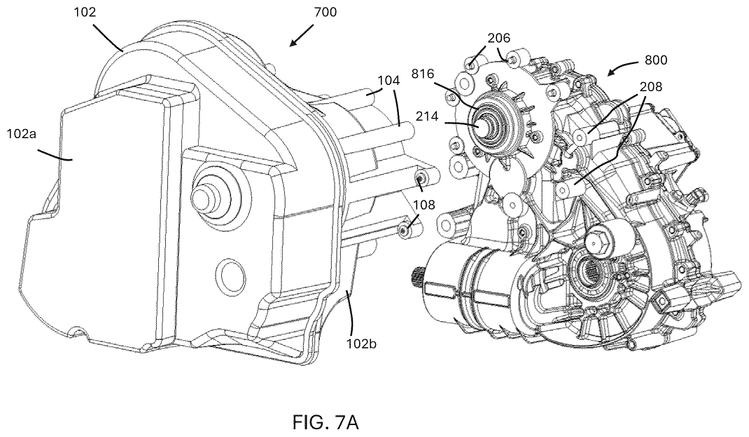

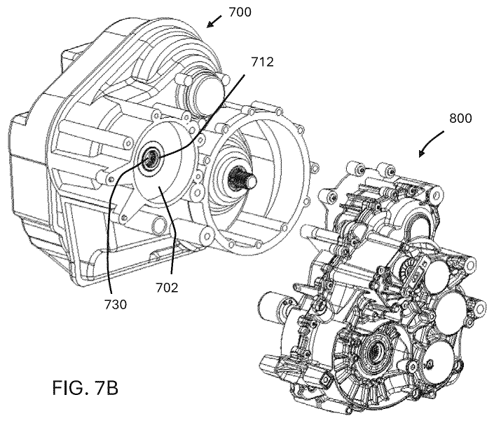

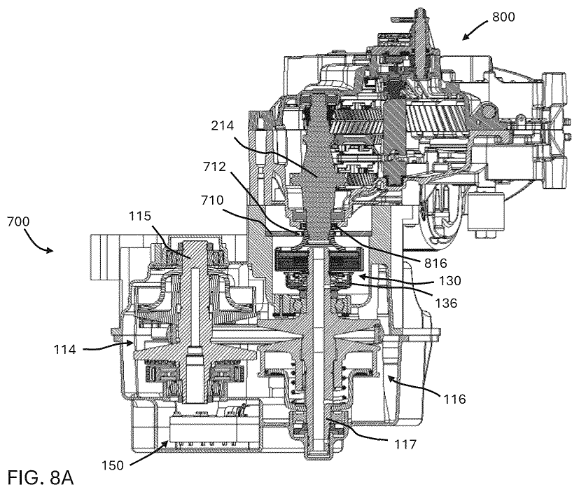

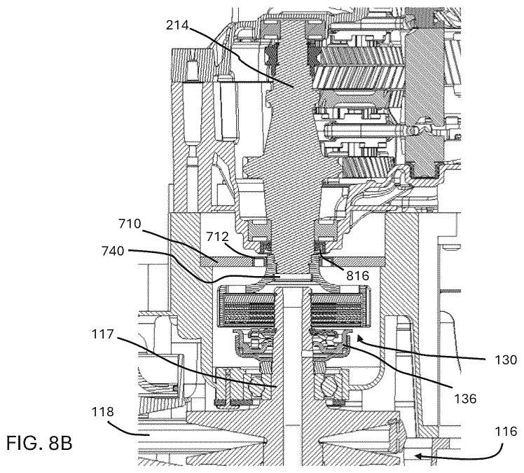

Another example of a modular SBCVT system 700 is illustrated in FIGS. 7A through 8B. The interface between an output of the modular SBCVT system 700 and the gearbox 800 is different than the embodiments described above. As illustrated in FIG. 7A, the gearbox 800 in this example includes the transmission input shaft 214 and a gearbox lip seal 816. FIG. 7B illustrates the modular SBCVT system 700 includes a SBCVT cover 702 around a SBCVT system output 730 of the modular SBCVT system 700. A SBCVT lip seal 712 is positioned around an output access to the SBCVT system output 730 of the modular SBCVT system 700 that receives the transmission input shaft 214 of the gearbox 800.

FIG. 8A illustrates a cross-sectional view of the modular SBCVT system 700 coupled to the gearbox 800. Further, FIG. 8B illustrates a close up partial view of the modular SBCVT system 700 coupled to the gearbox 800. As illustrated, the transmission input shaft 214 is received within the output access of the SBCVT cover 710 to the SBCVT system output 730 of modular SBCVT system 700. The SBCVT lip seal 712 retains hydraulic fluid within the modular SBCVT system 700. The gearbox lip seal 816 is positioned around the transmission input shaft 214 to retain gearbox fluid within the gearbox 800. Further, as best illustrated in FIG. 8B, an output plug 740 is used to seal off an inside diameter of the output access in the SBCVT cover 710. The output plug 740, the SBCVT lip seal 712, and the SBCVT cover 710 also seals off the modular SBCVT system 700 from the outside environment. The modular SBCVT system 700 bolts to the existing gearbox 800 using any or all of a bolt flange, existing engine mount bolts, additional bolt bosses, and/or additional bracketry.

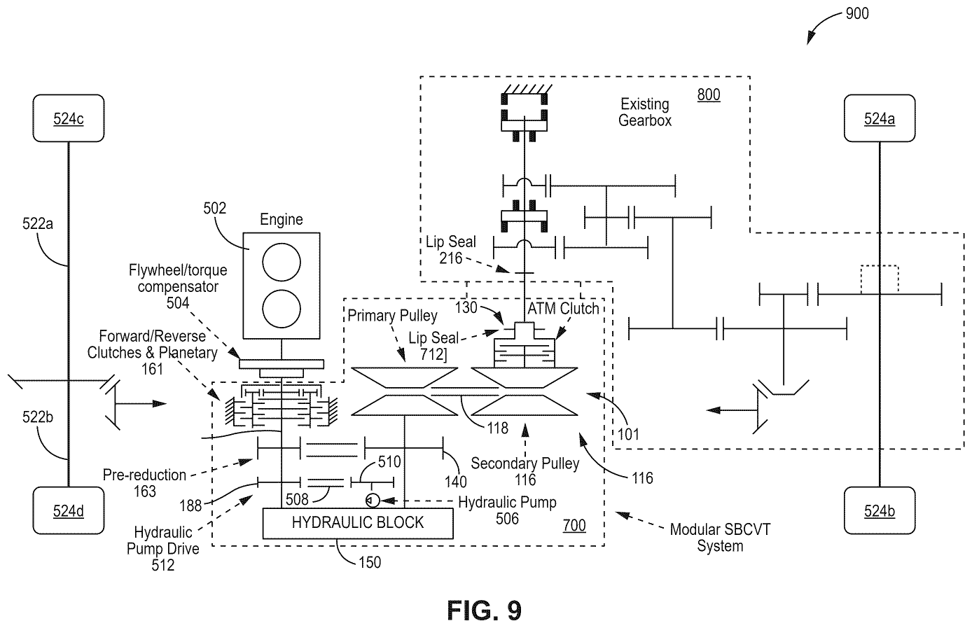

FIG. 9 includes a block diagram of an example vehicle 900 that includes the modular SBCVT system 700. Vehicle 900 includes an engine 502. In this example, a flywheel/torque compensator 504 is in operational communication with the engine 502. The flywheel/torque compensator 504 is in operational communication with the modular SBCVT system input shaft 166 of the modular SBCVT system 100. The hydraulic pump drive sprocket 188 further includes an endless looped member 508 and a hydraulic pump driven sprocket 510 of a hydraulic pump drive 512.

Torque from the gearbox 200 (transmission), is communicated to back wheels 524a and 524b and front wheels 524c and 524d of the vehicle 500 via back half shafts 520a and 520b and front shafts 522a and 522b and prop shafts 518a and 518a in this example.

In an example, the hydraulic pump drive sprocket 188 drives the hydraulic pump 506, which supplies hydraulic pressure to the hydraulic system 150 (hydraulic control unit). The primary movable sheave 114b is rotationally coupled to the primary fixed sheave 114a in an example. The steel belt 118 is rotationally coupled to the movable and fixed sheaves through clamp force which is supplied and controlled via the hydraulic system 150 (hydraulic control unit). A primary piston chamber 121 (best illustrated in FIG. 2A), which is made up of an interface between the primary stator 120 and the primary movable sheave 114b, applies the clamp force on the steel belt 118 through the primary movable sheave 114b. The primary movable sheave 114b can translate axially along the primary shaft 115 of the primary pulley 114, depending on the clamp force provided, to control the ratio of the steel belt CVT.

The steel belt 118 is rotationally coupled to the secondary pulley 116. A clamp force applied by the secondary movable sheave 116b on steel belt 118. A secondary piston chamber 125 is made by the interface between secondary stator 122 and the secondary movable sheave 116b (as best illustrated in FIG. 2B). The clamp force is supplied by the hydraulic system 150. The clamp force can vary, which allows the secondary movable sheave 116b to translate axially along the secondary shaft 117, in unison with the translation of the primary movable sheave 114b to change the ratio of the SBCVT.

Also illustrated in the block diagram of the vehicle is the SBCVT lip seal 712 of modular SBCVT system 700 and the gearbox lip seal 816 of gearbox 800.

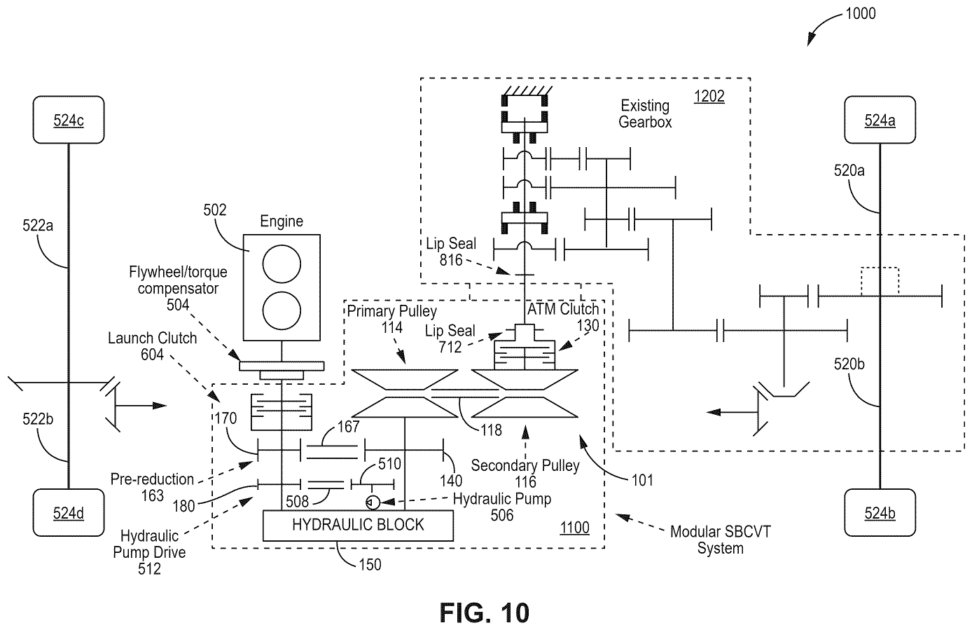

Another example of the vehicle 1000 is illustrated in FIG. 10. In this example, the modular SBCVT system 1100 replaces the forward/reverse clutch and planetary 161 with a launch clutch 604. The launch clutch 604 is positioned between the flywheel/torque compensator 504 and the pre-reduction drive gear 170 of the pre-reduction system 163. The hydraulic system 150 controls the operation of the launch clutch 604. In this example, the gearbox 1200 includes the forward/reverse gearing.

Examples described above include either a forward/reverse clutch and planetary 161 or a launch clutch 604. Other embodiments may not include one or more of the ATM clutch 130 and the pre-reduction system 163.

### EXAMPLE EMBODIMENTS

Example 1 includes a modular SBCVT system. The system includes a housing, a SBCVT, a hydraulic system, and a SBCVT system output. The CVT is contained within the housing. The SBCVT includes a primary pulley, a secondary pulley and steel belt. The primary pulley in operational communication to receive engine torque. The steel belt is in operational communication with the primary pulley and the secondary pulley to convey torque between the primary pulley and the secondary pulley. The hydraulic system is contained within the housing. the hydraulic system configured to control at least the primary pulley and the secondary pulley. The SBCVT system output is in operational communication with the secondary pulley of the SBCVT. The SBCVT system output is configured to engage an input shaft of a gearbox.

Example 2 includes the system of Example 1, furthering including an ATM clutch that is contained within the housing. The ATM clutch is in operational communication with the secondary pulley of the CVT, wherein the hydraulic system is further configured to control the ATM clutch, and wherein the SBCVT system output is in operational communication with the ATM clutch.

Example 3 includes the system of any of the Examples 1-2, further including a pre-reduction system configured to communicate engine torque to the primary pulley of the SBCVT.

Example 4 includes the system of any of the Examples 1-3, further including a forward launch clutch that is positioned between an engine and the primary pulley of the SBCVT. The hydraulic system configured to control the forward launch clutch.

Example 5 includes the system of any of the Examples 1-4, further including a forward/reverse system that is positioned between an engine and the primary pulley of the SBCVT. The hydraulic system configured to control the forward/reverse system.

Example 6 includes the system of any of the Examples 1-5, further including a seal that is positioned around the input shaft of the gearbox to retain hydraulic fluid within the housing of the SBCVT system.

Examples 7 includes the system of any of the Examples 1-6, further including a gasket face that is positioned between the SBCVT system housing, and the housing of the existing gearbox, to retain hydraulic fluid within the housing of the SBCVT system.

Example 8 includes a modular SBCVT system. The system includes a housing with the SBCVT contained within the housing. The SBCVT includes a primary pulley in operational communication to receive engine torque, a secondary pulley, and a steel belt. The steel belt is in operational communication with the primary pulley and the secondary pulley to convey torque between the primary pulley and the secondary pulley. An active torque management (ATM) clutch is contained within the housing. The ATM clutch is in operational communication with the secondary pulley of the SBCVT. A hydraulic system is contained within the housing. The hydraulic system is configured to control at least the primary pulley, the secondary pulley and the ATM clutch. The SBCVT system output is in operational communication with the secondary pulley of the SBCVT. The SBCVT system output is configured to engage an input shaft of a gearbox. A seal is positioned around the input shaft of the gearbox to retain hydraulic fluid within the housing of the SBCVT system.

Example 9 includes the system of Example 8, wherein the SBCVT system output is in operational communication with the ATM clutch.

Example 10 includes the system of any of the Examples 8-9, further including a pre-reduction system configured to communicate engine torque to the primary pulley of the SBCVT.

Example 11 includes the system of Example 8-10, further including a forward launch clutch positioned between an engine and the primary pulley of the SBCVT, The hydraulic system configured to control the forward launch clutch.

Example 12 includes the system of any of the Examples 8-11, further including a forward/reverse system positioned between an engine and the primary pulley of the SBCVT. The hydraulic system configured to control the forward/reverse system.

Example 13 includes a vehicle including an engine to generate engine torque and a modular SBCVT system. The SBCVT system includes a housing. A SBCVT is contained within the housing. The SBCVT includes a primary pulley, a secondary pulley, and a steel belt. The primary pulley is in operational communication to receive engine torque. The steel belt is in operational communication with the primary pulley and the secondary pulley to convey torque between the primary pulley and the secondary pulley. A hydraulic system is contained within the housing. The hydraulic system is configured to control at least the primary pulley and the secondary pulley. A SBCVT system output is in operational communication with the secondary pulley of the SBCVT. The SBCVT system output is configured to engage an input shaft of a gearbox. The gearbox is in operational communication with the SBCVT system. Wheels are in operational communication with the gearbox.

Example 14 includes the vehicle of Example 13 wherein the SBCVT further includes an active torque management (ATM) clutch that is contained within the housing, the ATM clutch is in operational communication with the secondary pulley of the SBCVT.

Example 15 includes the vehicle of Example 14, wherein the hydraulic system is further configured to control the ATM clutch.

Example 16 includes the vehicle of any of the Examples 14-15, wherein the SBCVT system output is in operational communication with the ATM clutch.

Example 17 includes the vehicle of any of the Examples 13-16, wherein the SBCVT further includes a pre-reduction system configured to communicate engine torque to the primary pulley of the SBCVT.

Example 18 includes the vehicle of any of the Examples 13-17, further including a forward launch clutch that is positioned between an engine and the primary pulley of the SBCVT. The hydraulic system configured to control the forward launch clutch.

Example 19 includes the vehicle of any of the Examples 13-18, wherein the SBCVT further includes a forward/reverse system positioned between an engine and the primary pulley of the SBCVT, the hydraulic system configured to control the forward/reverse system.

Example 20 includes the vehicle of any of the Examples 13-19, further including a seal positioned around the input shaft of the gear box to retain hydraulic fluid within the housing of the SBCVT system.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A modular steel belt continuously variable transmission (SBCVT) system, the system comprising:
a housing;
a SBCVT contained within the housing, the SBCVT includes,
a primary pulley in operational communication to receive engine torque,
a secondary pulley, and
a steel belt in operational communication with the primary pulley and the secondary pulley to convey torque between the primary pulley and the secondary pulley;
a hydraulic system contained within the housing, the hydraulic system configured to control at least the primary pulley and the secondary pulley; and
a SBCVT system output in operational communication with the secondary pulley of the SBCVT, the SBCVT system output configured to engage an input shaft of a gearbox.

2. The system of claim 1, further comprising:
an active torque management (ATM) clutch contained within the housing, the ATM clutch is in operational communication with the secondary pulley of the SBCVT, wherein the hydraulic system is further configured to control the ATM clutch, and wherein the SBCVT system output is in operational communication with the ATM clutch.

3. The system of claim 1, further comprising:
a pre-reduction system configured to communicate the engine torque to the primary pulley of the SBCVT.

4. The system of claim 1, further comprising:
a forward launch clutch positioned between an engine and the primary pulley of the SBCVT, the hydraulic system configured to control the forward launch clutch.

5. The system of claim 1, further comprising:
a forward/reverse system positioned between an engine and the primary pulley of the SBCVT, the hydraulic system configured to control the forward/reverse system.

6. The system of claim 1, further comprising:
a seal positioned around the input shaft of the gearbox to retain hydraulic fluid within the housing of the SBCVT system.

7. The system of claim 1, further comprising:
a gasket face positioned between the SBCVT system housing, and a housing of the gearbox, to retain hydraulic fluid within the housing of the SBCVT system.

8. A modular steel belt continuously variable transmission (SBCVT) system, the system comprising:
a housing;
a SBCVT contained within the housing, the SBCVT includes,
a primary pulley in operational communication to receive engine torque,
a secondary pulley, and
a steel belt in operational communication with the primary pulley and the secondary pulley to convey torque between the primary pulley and the secondary pulley;
an active torque management (ATM) clutch contained within the housing, the ATM clutch is in operational communication with the secondary pulley of the SBCVT;
a hydraulic system contained within the housing, the hydraulic system configured to control at least the primary pulley, the secondary pulley and the ATM clutch;
a SBCVT system output in operational communication with the secondary pulley of the SBCVT, the SBCVT system output configured to engage an input shaft of a gearbox; and
a seal positioned around the input shaft of the gearbox to retain hydraulic fluid within the housing of the SBCVT system.

9. The system of claim 8, wherein the SBCVT system output is in operational communication with the ATM clutch.

10. The system of claim 8, further comprising:
a pre-reduction system configured to communicate engine torque to the primary pulley of the SBCVT.

11. The system of claim 8, further comprising:
a forward launch clutch positioned between an engine and the primary pulley of the SBCVT, the hydraulic system configured to control the forward launch clutch.

12. The system of claim 8, further comprising:
a forward/reverse system positioned between an engine and the primary pulley of the SBCVT, the hydraulic system configured to control the forward/reverse system.

13. A vehicle comprising:
an engine to generate engine torque;
a modular steel belt continuously variable transmission (SBCVT) system including,
a housing,
a SBCVT contained within the housing, the SBCVT includes,
a primary pulley in operational communication to receive engine torque,
a secondary pulley, and
a steel belt in operational communication with the primary pulley and the secondary pulley to convey torque between the primary pulley and the secondary pulley,
a hydraulic system contained within the housing, the hydraulic system configured to control at least the primary pulley and the secondary pulley, and
a SBCVT system output in operational communication with the secondary pulley of the SBCVT;
a gearbox in operational communication with the SBCVT system, the gearbox including an input shaft configured to engage the SBCVT system output; and
wheels in operational communication with the gearbox.

14. The vehicle of claim 13, wherein the SBCVT further comprises:
an active torque management (ATM) clutch contained within the housing, the ATM clutch is in operational communication with the secondary pulley of the SBCVT.

15. The vehicle of claim 14, wherein the hydraulic system is further configured to control the ATM clutch.

16. The vehicle of claim 14, wherein the SBCVT system output is in operational communication with the ATM clutch.

17. The vehicle of claim 13, wherein the SBCVT further comprises:
a pre-reduction system configured to communicate engine torque to the primary pulley of the SBCVT.

18. The vehicle of claim 13, wherein the SBCVT further comprises:
a forward launch clutch positioned between an engine and the primary pulley of the SBCVT, the hydraulic system configured to control the forward launch clutch.

19. The vehicle of claim 13, wherein the SBCVT further comprises:
a forward/reverse system positioned between an engine and the primary pulley of the SBCVT, the hydraulic system configured to control the forward/reverse system.

20. The vehicle of claim 13, further comprising:
a seal positioned around the input shaft of the gearbox to retain hydraulic fluid within the housing of the SBCVT system.
